(19) United States
(12) Patent Application Publication
(10) Pub. No.: US 2025/0109556 A1
(43) Pub. Date: Apr. 3, 2025

(54) Method and Apparatus to Infer Structural Response from User-Device Measurements

(71) Applicant: Southern Methodist University, Dallas, TX (US)

(72) Inventors: Brett Story, Rockwall, TX (US); Dinesh Rajan, Dallas, TX (US); Joseph Camp, Dallas, TX (US); Matthew Napier-Jameson, Dallas, TX (US)

(21) Appl. No.: 18/977,358

(22) Filed: Dec. 11, 2024

Related U.S. Application Data
(63) Continuation-in-part of application No. 17/725,195, filed on Apr. 20, 2022.
Application No. 17/725,195 is a continuation-in-part of application No. 15/880,990, filed on Jan. 26, 2018, now Pat. No. 10,283,579.
(60) Provisional application No. 62/415,654, filed on Nov. 1, 2016.

(51) Int. Cl. E01D 22/00; G01H 17/00

(52) U.S. Cl. CPC E01D 22/00; G01H 17/00

(57) ABSTRACT

The present invention includes a method for detecting impairments of a structure in the absence of permanent sensor systems comprising: obtaining time-varying sensor data on a user device; filtering the time-varying sensor data obtained by the user device to determine a vibration response from structural infrastructure; and estimating structural responses of the structure by comparing at least one of: dynamic (short-term) sensor data to an analytical model of the structure; or dynamic sensor data from different user devices at different points in time (long-term), to determine if there has been any significant change in the structure with time.

### CROSS-REFERENCE TO RELATED APPLICATIONS

This application is a continuation-in-part patent application of U.S. non-provisional patent application Ser. No. 17/725,195 filed on Apr. 20, 2022, which is a continuation-in-part patent application of U.S. non-provisional patent application Ser. No. 15/800,990 filed on Nov. 1, 2017 (abandoned), which claims priority to U.S. provisional patent application Ser. No. 62/415,654 filed on Nov. 1, 2016 and entitled “Method and Apparatus to Infer Structural Response from User-Device Measurements”, the contents of which are hereby incorporated by reference in their entirety.

### STATEMENT OF FEDERALLY FUNDED RESEARCH

None.

### TECHNICAL FIELD OF THE INVENTION

The present invention relates in general to the field of the study of structural systems, and more particularly, to a method using user-device measurements to infer structural responses of infrastructure.

### BACKGROUND OF THE INVENTION

Without limiting the scope of the invention, its background is described in connection with assessing dynamic behavior of structural systems.

Acceleration data is one ubiquitous method of assessing dynamic behavior of structural systems (Farrar et al. 2001, Brownjohn 2007, Antunes et al. 2014). Dynamic characteristics such as natural frequency and acceleration magnitudes are readily estimated through implementation of piezoelectric, MEMS or other acceleration devices (Antunes et al. 2014, Ha et al. 2013, Park et al. 2005). Widespread implementation has been hindered by: instrumentation cost, installation and maintenance logistics, and data processing issues. The proposed method circumvents many of these issues by leveraging data from smartphones carried by those utilizing structural systems (e.g. bridges, walkways). Cell phones have been used to collect data from structures before (Feng et al. 2015, Ozer et al. 2015). Feng et al. confirms that the micro-electro-mechanical (MEMS) accelerometers found in smart phones record acceleration data comparable to a research grade piezoelectric accelerometer. Ozer et al. 2015 focuses on the data acquisition and storage of crowd sourced data; the engineering quantities of interest in this study were limited to natural frequencies.

### SUMMARY OF THE INVENTION

In contrast to prior methods, the present invention method uses community-driven data to obtain data from infrastructure to provide direct feedback on the health of the structure in a field setting in real-time or nearly real-time. As embodied and broadly described herein, an aspect of the present disclosure relates to a method for detecting and correcting impairments of a bridge structure in the absence of permanent sensor systems comprising: measuring a frequency of the bridge structure at a first time; obtaining time-varying sensor data on a user device from the bridge structure; estimating structural responses of the bridge structure by comparing at least one of: dynamic (short-term) sensor data to an analytical model of the bridge structure; or dynamic sensor data from different user devices at different points in time (long-term), to determine if there has been any significant change in the bridge structure with time; filtering the time-varying sensor data obtained by the multiple user devices or the same device multiple times and to filter a frequency of a user, at least one of: acceleration, GPS data, vehicle frequency, or acceleration amplitude of a vehicle, or both, that cause a vibration of the bridge structure to obtain: a frequency domain acceleration of the bridge structure, and a frequency domain displacement of the bridge structure; and using one or more processors, performing an inverse discrete Fourier transform (IFFT) on the filtered frequency domain acceleration and the frequency domain displacement to calculate a final time domain displacement of the bridge structure to determine impairments of the bridge structure in the absence of permanent sensor systems; inspecting the bridge structure for structural impairments; converting the accelerations into displacements, strains, and stresses of the bridge structure; using the final time domain displacement of the bridge structure to determine impairments of the bridge structure and based on the final time domain displacement; repairing the bridge structure by adding mass, modifying structural stiffness to repair damage to the bridge structure, adding supports, or modifying the bridge structure until the frequency of the bridge structure is at or about the frequency measured at the first time. In one aspect, the repairs are selected from lubricating, repairing or replacing a bearing, patching deteriorated or missing concrete, adding reinforcing girders, or reinforcing steel. In another aspect, the time-varying sensor information is captured by a smartphone and the time-varying sensor information is selected from 3D accelerometer, gyroscope and GPS information. In another aspect, the time-varying sensor information is obtained without user-specific identification. In another aspect, the time-varying sensor information is uploaded to a server and stored for subsequent analysis. In another aspect, the time-varying sensor data is filtered by vehicle frequencies. In another aspect, the method distinguishes vibration response of supporting structural infrastructure is selected from frequencies and/or acceleration time histories. In another aspect, the user device comprises an application that requires user opt-in to gather the time-varying sensor data. In another aspect, the method further comprises the step of calculating a structural behavior profile from analytical models for a typical structure and comparing the structural behavior profile to the time-varying sensor data obtained from the user devices to the calculated structural behavior profile. In another aspect, the method further comprises the steps of obtaining time-varying sensor data; filtering the time-varying sensor data; and estimating structural responses is conducted via a code segment in non-transitory memory.

As embodied and broadly described herein, an aspect of the present disclosure relates to a method for detecting impairments of a bridge structure in the absence of permanent sensor systems comprising: measuring or obtaining a frequency of the bridge structure at a first time; obtaining time-varying sensor data on a smartphone with an application that requires user opt-in to gather the time-varying sensor data; estimating structural responses of the bridge structure to an analytical model and an existing data set for the same structure from the time-varying sensor data obtained from different smartphones to determine if there has been any significant change in the bridge structure with time; filtering the time-varying sensor data obtained by the user device to distinguish vibration response of the bridge structure that includes at least one of: 3D accelerometer, gyroscope and GPS information that cause a vibration of the bridge structure to obtain: a frequency domain acceleration of the bridge structure, and a frequency domain displacement of the bridge structure; using one or more processors, performing an inverse discrete Fourier transform (IFFT) on the filtered frequency domain acceleration and the frequency domain displacement; generating a final time domain displacement of the bridge structure to determine impairments of the bridge structure in the absence of permanent sensor systems; inspecting the bridge structure for structural impairments; converting the accelerations into displacements, strains, and stresses of the bridge structure; monitoring, using the time-varying sensor data on the smartphone, the bridge structure, until the frequency of the bridge structure is obtained by comparing the frequency measured at the first time and a later measured frequency, and based on the final time domain displacement; and repairing the bridge structure to a frequency similar to that when the bridge structure was first installed. In one aspect, the repairs are selected from lubricating, repairing or replacing a bearing, patching deteriorated or missing concrete, adding reinforcing girders, or reinforcing steel. In one aspect, the time-varying sensor information is obtained without user-specific identification. In another aspect, the time-varying sensor information is uploaded to a server and stored for subsequent analysis. In another aspect, the time-varying sensor data is filtered by vehicle frequencies. In another aspect, the method further comprises distinguishing vibration response of supporting structural infrastructure is selected from frequencies and/or acceleration time histories. In another aspect, the time smartphones comprises an application that requires user opt-in to gather the time-varying sensor data. In another aspect, the method further comprises the step of calculating a structural behavior profile from analytical models for a typical structure and comparing the structural behavior profile to the time-varying sensor data obtained from the smartphone to the calculated structural behavior profile.

As embodied and broadly described herein, an aspect of the present disclosure relates to a non-transitory computer readable medium for detecting impairments of a bridge structure in the absence of permanent sensor systems via crowdsourcing, comprising instructions stored thereon, that when executed by a computer having a communications interface, one or more databases and one or more processors communicably coupled to the interface and one or more databases, perform the steps comprising: measuring or obtaining a frequency of the bridge structure at a first time; obtaining time-varying sensor data on a user device from the bridge structure; using the one or more processors, estimating structural responses of the bridge structure by comparing at least one of: dynamic (short-term) sensor data to an analytical model of the bridge structure; or dynamic sensor data from different user devices at different points in time (long-term), to determine if there has been any significant change in the bridge structure with time; filtering the time-varying sensor data obtained by the multiple user devices or the same device multiple times and to filter a frequency of a user, at least one of: acceleration, GPS data, vehicle frequency, or acceleration amplitude of a vehicle, or both, that cause a vibration of the bridge structure to obtain: a frequency domain acceleration of the bridge structure, and a frequency domain displacement of the bridge structure; using the one or more processors, performing an inverse discrete Fourier transform (IFFT) on the filtered frequency domain acceleration and the frequency domain displacement; generating a final time domain displacement of the bridge structure to determine impairments of the bridge structure in the absence of permanent sensor systems; outputting a list of structural impairments; converting the accelerations into displacements, strains, and stresses of the bridge structure; and using the displacements, strains, and stresses of the bridge structure to provide instructions with repairs to the bridge structure by adding mass, modifying structural stiffness, repairing damage to the bridge structure, adding supports, or modifying the bridge structure until the frequency of the bridge structure is at or about the frequency measured at the first time; at least one of storing or displaying the results obtained thereby; and repairing the bridge structure to a frequency similar to that when the bridge structure was first installed using the instructions with repairs for the bridge structure based on the final time domain displacement. As embodied and broadly described herein, an aspect of the present disclosure relates to a computerized method for detecting and correcting impairments of a bridge structure in the absence of permanent sensor systems via crowdsourcing, comprising: measuring or obtaining a frequency of the bridge structure at a first time; obtaining time-varying sensor data on a user device from the bridge structure; using one or more processors, estimating structural responses of the bridge structure by comparing at least one of: dynamic (short-term) sensor data to an analytical model of the bridge structure; or dynamic sensor data from different user devices at different points in time (long-term), to determine if there has been any significant change in the bridge structure with time; filtering the time-varying sensor data obtained by the multiple user devices or the same device multiple times and to filter a frequency of a user, at least one of: acceleration, GPS data, vehicle frequency, or acceleration amplitude of a vehicle, or both, that cause a vibration of the bridge structure to obtain: a frequency domain acceleration of the bridge structure, and a frequency domain displacement of the bridge structure; using the one or more processors, performing an inverse discrete Fourier transform (IFFT) on the filtered frequency domain acceleration and the frequency domain displacement; generating a final time domain displacement of the bridge structure to determine impairments of the bridge structure in the absence of permanent sensor systems; outputting a list of structural impairments; converting the accelerations into displacements, strains, and stresses of the bridge structure; using the displacements, strains, and stresses of the bridge structure to generate instructions to repair the bridge structure by adding mass, modifying structural stiffness, repairing damage to the bridge structure, adding supports, or modifying the bridge structure until the frequency of the bridge structure is at or about the frequency measured at the first time; and repairing the bridge structure to a frequency similar to that when the bridge structure was first installed using the instructions with repairs for the bridge structure based on the final time domain displacement.

Another embodiment of the present invention includes a method for detecting impairments of a structure in the absence of permanent sensor systems comprising: obtaining time-varying sensor data on a user device; filtering the time-varying sensor data obtained by the user device to determine a vibration response from structural infrastructure; and estimating structural responses of the structure by comparing the dynamic (short-term) sensor data to an analytical model of the structure; also comparing the dynamic sensor data from different user devices at different points in time (long-term) to determine if there has been any significant change with time. In one aspect, the time-varying sensor information on the smartphone is selected from 3D accelerometer, gyroscope and GPS information. In another aspect, the time-varying sensor information is obtained without user-specific identification. In another aspect, the time-varying sensor information is uploaded to a server and stored for subsequent analysis. In another aspect, the time-varying sensor data is filtered to remove frequencies of vehicle used to collect data. In another aspect, to distinguish vibration response of supporting structural infrastructure is selected from frequencies and/or acceleration time histories. In another aspect, the finding of significant changes triggers additional action to closely inspect the structure for potential impairments. In another aspect, the user device comprises an application that requires user opt-in to gather the time-varying sensor data. In another aspect, the method further comprises the converting of the time-varying sensor data directly into at least one of: displacements, strains, or stresses to determine the response of the structure and characterize the fatigue environment. In another aspect, the method further comprises calculating a structural behavior profile from analytical models for a typical structure and comparing the structural behavior profile to the time-varying sensor data obtained from the user devices to the calculated structural behavior profile. In another aspect, the steps of obtaining time-varying sensor data; filtering the time-varying sensor data; and estimating structural responses is conducted via a code segment in non-transitory memory.

As embodied and broadly described herein, an aspect of the present disclosure relates to a method for detecting impairments of a structure in the absence of permanent sensor systems comprising: measuring a frequency of the structure at a first time; obtaining time-varying sensor data on a user device of the structure; estimating structural responses of the structure by comparing at least one of: dynamic (short-term) sensor data to an analytical model of the structure; or dynamic sensor data from different user devices at different points in time (long-term), to determine if there has been any significant change in the structure with time; filtering the time-varying sensor data obtained by the multiple user devices or the same device multiple times and to filter a frequency of a user, at least one of: acceleration, GPS data, vehicle frequency, or acceleration amplitude of a vehicle, or both, that cause a vibration of the structure to obtain: a frequency domain acceleration of the structure, and a frequency domain displacement of the structure; performing an inverse discrete Fourier transform (IFFT) on the filtered frequency domain acceleration and the frequency domain displacement; generating a final time domain displacement of the structure to determine impairments of the structure in the absence of permanent sensor systems; inspecting the structure for structural impairments; converting the accelerations into displacements, strains, and stresses of the structure; and correcting the structure by adding mass, modifying structural stiffness, repairing damage to the structure, adding supports, or modifying the structure until the frequency of the structure is at or about the frequency measured at the first time. In one aspect, the time-varying sensor information on the smartphone is selected from 3D accelerometer, gyroscope and GPS information. In another aspect, the time-varying sensor information is obtained without user-specific identification. In another aspect, the time-varying sensor information is uploaded to a server and stored for subsequent analysis. In another aspect, the time-varying sensor data is filtered by vehicle frequencies. In another aspect, to distinguish vibration response of supporting structural infrastructure is selected from frequencies and/or acceleration time histories. In another aspect, the finding of significant changes in frequency from the first time triggers additional action to closely inspect the structure for potential impairments. In another aspect, the user device comprises an application that requires user opt-in to gather the time-varying sensor data. In another aspect, the method further comprises the step of calculating a structural behavior profile from analytical models for a typical structure and comparing the structural behavior profile to the time-varying sensor data obtained from the user devices to the calculated structural behavior profile. In another aspect, the steps of obtaining time-varying sensor data; filtering the time-varying sensor data; and estimating structural responses is conducted via a code segment in non-transitory memory.

As embodied and broadly described herein, an aspect of the present disclosure relates to a method for detecting impairments of a structure in the absence of permanent sensor systems comprising: measuring or obtaining a frequency of the structure at a first time; obtaining time-varying sensor data on a smartphone with an application that requires user opt-in to gather the time-varying sensor data; estimating structural responses of the structure to an analytical model and an existing data set for the same structure from the time-varying sensor data obtained from different smartphones to determine if there has been any significant change in the structure with time; filtering the time-varying sensor data obtained by the user device to distinguish vibration response of the structure that includes at least one of: 3D accelerometer, gyroscope and GPS information that cause a vibration of the structure to obtain: a frequency domain acceleration of the structure, and a frequency domain displacement of the structure; performing an inverse discrete Fourier transform (IFFT) on the filtered frequency domain acceleration and the frequency domain displacement; generating a final time domain displacement of the structure to determine impairments of the structure in the absence of permanent sensor systems; inspecting the structure for structural impairments; converting the accelerations into displacements, strains, and stresses of the structure; and monitoring, using the time-varying sensor data on the smartphone, the structure until the frequency of the structure by comparing the frequency measured at the first time and a later measured frequency. In one aspect, the time-varying sensor information is obtained without user-specific identification. In another aspect, the time-varying sensor information is uploaded to a server and stored for subsequent analysis. In another aspect, the time-varying sensor data is filtered by vehicle frequencies. In another aspect, to distinguish vibration response of supporting structural infrastructure is selected from frequencies and/or acceleration time histories. In another aspect, the finding of significant changes triggers additional action to closely inspect the structure for potential impairments. In another aspect, the smartphone comprises an application that requires user opt-in to gather the time-varying sensor data. In another aspect, the method further comprises the step of calculating a structural behavior profile from analytical models for a typical structure and comparing the structural behavior profile to the time-varying sensor data obtained from the smartphone to the calculated structural behavior profile.

As embodied and broadly described herein, an aspect of the present disclosure relates to a non-transitory computer readable medium for detecting impairments of a structure in the absence of permanent sensor systems via crowdsourcing, comprising instructions stored thereon, that when executed by a computer having a communications interface, one or more databases and one or more processors communicably coupled to the interface and one or more databases, perform the steps comprising: measuring or obtaining a frequency of the structure at a first time; obtaining time-varying sensor data on a user device of the structure; estimating structural responses of the structure by comparing at least one of: dynamic (short-term) sensor data to an analytical model of the structure; or dynamic sensor data from different user devices at different points in time (long-term), to determine if there has been any significant change in the structure with time; filtering the time-varying sensor data obtained by the multiple user devices or the same device multiple times and to filter a frequency of a user, at least one of: acceleration, GPS data, vehicle frequency, or acceleration amplitude of a vehicle, or both, that cause a vibration of the structure to obtain: a frequency domain acceleration of the structure, and a frequency domain displacement of the structure; performing an inverse discrete Fourier transform (IFFT) on the filtered frequency domain acceleration and the frequency domain displacement; generating a final time domain displacement of the structure to determine impairments of the structure in the absence of permanent sensor systems; inspecting the structure for structural impairments; converting the accelerations into displacements, strains, and stresses of the structure; and correcting the structure by adding mass, modifying structural stiffness, repairing damage to the structure, adding supports, or modifying the structure until the frequency of the structure is at or about the frequency measured at the first time; and optionally at least one of storing or displaying the results obtained thereby.

As embodied and broadly described herein, an aspect of the present disclosure relates to a computerized method for detecting impairments of a structure in the absence of permanent sensor systems via crowdsourcing, comprising: measuring or obtaining a frequency of the structure at a first time; obtaining time-varying sensor data on a user device of the structure; estimating structural responses of the structure by comparing at least one of: dynamic (short-term) sensor data to an analytical model of the structure; or dynamic sensor data from different user devices at different points in time (long-term), to determine if there has been any significant change in the structure with time; filtering the time-varying sensor data obtained by the multiple user devices or the same device multiple times and to filter a frequency of a user, at least one of: acceleration, GPS data, vehicle frequency, or acceleration amplitude of a vehicle, or both, that cause a vibration of the structure to obtain: a frequency domain acceleration of the structure, and a frequency domain displacement of the structure; performing an inverse discrete Fourier transform (IFFT) on the filtered frequency domain acceleration and the frequency domain displacement; generating a final time domain displacement of the structure to determine impairments of the structure in the absence of permanent sensor systems; inspecting the structure for structural impairments; converting the accelerations into displacements, strains, and stresses of the structure; and correcting the structure by adding mass, modifying structural stiffness, repairing damage to the structure, adding supports, or modifying the structure until the frequency of the structure is at or about the frequency measured at the first time.

In another embodiment, the present invention also includes a method for detecting impairments of a structure in the absence of permanent sensor systems comprising: obtaining time-varying sensor data on a smartphone with an application that requires user opt-in to gather the time-varying sensor data; filtering the time-varying sensor data obtained by the smartphone to distinguish vibration response of the structure that includes at least one of: 3D accelerometer, gyroscope and GPS information; and estimating structural responses of the structure to an analytical model and an existing data set for the same structure from the time-varying sensor data obtained from different smartphones to determine if there has been any significant change in the structure with time. In one aspect, the time-varying sensor information is obtained without user-specific identification. In another aspect, the time-varying sensor information is uploaded to a server and stored for subsequent analysis. In another aspect, the time-varying sensor data is filtered by vehicle frequencies. In another aspect, to distinguish vibration response of supporting structural infrastructure is selected from frequencies and/or acceleration time histories. In another aspect, the finding of significant changes triggers additional action to closely inspect the structure for potential impairments. In another aspect, the smartphone comprises an application that requires user opt-in to gather the time-varying sensor data. In another aspect, the method further comprises the step of converting the time-varying sensor data directly into at least one of: displacements, strains, or stresses to determine the response of the structure and characterize the fatigue environment. In another aspect, the method further comprises the step of calculating a structural behavior profile from analytical models for a typical structure and comparing the structural behavior profile to the time-varying sensor data obtained from the smartphone to the calculated structural behavior profile.

Yet another embodiment of the present invention includes a non-transitory computer readable medium for detecting impairments of a structure in the absence of permanent sensor systems via crowdsourcing, comprising instructions stored thereon, that when executed by a computer having a communications interface, one or more databases and one or more processors communicably coupled to the interface and one or more databases, perform the steps comprising: obtaining time-varying sensor data on a user device; filtering the time-varying sensor data obtained by the user device to distinguish vibration response of the structure that includes at least one of: 3D accelerometer, gyroscope and GPS information; and estimating structural responses of the structure to an analytical model and an existing data set for the same structure from the time-varying sensor data obtained from different user devices to determine if there has been any significant change in the structure with time; and at least one of storing or displaying the results obtained thereby.

Yet another embodiment of the present invention includes a computerized method for detecting impairments of a structure in the absence of permanent sensor systems via crowdsourcing, comprising: obtaining time-varying sensor data on a user device; filtering the time-varying sensor data obtained by the user device to distinguish vibration response of the structure that includes at least one of: 3D accelerometer, gyroscope and GPS information; estimating structural responses of the structure to an analytical model and an existing data set for the same structure from the time-varying sensor data obtained from different user devices to determine if there has been any significant change in the structure with time; and at least one of storing or displaying the results obtained thereby.

### BRIEF DESCRIPTION OF THE DRAWINGS

For a more complete understanding of the features and advantages of the present invention, reference is now made to the detailed description of the invention along with the accompanying figures and in which:

FIG. 1 is a flow diagram for separating user device and infrastructure responses.

FIG. 2 includes three graphs that provide the frame SRE Lab Summary.

FIG. 3 shows the SRE frequency estimation for the stationary test.

FIG. 4 shows the unfiltered frequency response of the walking test (Bike Walk Test: Bridge vs. Cell Phone response (after SRE)).

FIGS. 5A and 5B show individual run FFTs: FIG. 5A baseline (undamaged) vs. FIG. 5B lengthened span (damaged).

FIGS. 6A and 6B show average FFTs: FIG. 6A baseline (undamaged) vs. FIG. 6B baseline lengthened span (damaged).

FIGS. 7A and 7B show individual run FFTs: FIG. 7A baseline (undamaged) vs. FIG. 7B added mass (damaged).

FIGS. 8A and 8B show average FFTs: FIG. 8A baseline (undamaged) vs. FIG. 8B added mass (damaged).

FIG. 9 shows a flowchart of post-frequency detection actions.

FIG. 10 shows a nominal bridge in ANSYS engineering simulation and 3D design software.

FIG. 11 shows a flowchart of a bridge with the bearing failure and repair of the bearing.

FIG. 12 shows a bridge in ANSYS model of concrete section loss.

FIG. 13 shows a flowchart of a bridge with the concrete section loss and repair of the concrete section loss.

FIG. 14 shows a flowchart of a method of the present disclosure for detecting and correcting impairments of a bridge structure in the absence of permanent sensor systems.

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

To facilitate the understanding of this invention, a number of terms are defined below. Terms defined herein have meanings as commonly understood by a person of ordinary skill in the areas relevant to the present invention. Terms such as “a”, “an” and “the” are not intended to refer to only a singular entity, but include the general class of which a specific example may be used for illustration. The terminology herein is used to describe specific embodiments of the invention, but their usage does not delimit the invention, except as outlined in the claims.

Detecting the structural impairments of physical structures is important to ensure their continued functionality and prevent losses due to structural failures. Traditional methods for detecting such impairments include: (i) visual inspection by experienced engineers, or (ii) measurements from the structure using fixed sensors such as strain gauges or accelerometers. Permanent monitoring systems can be expensive and difficult to install and maintain.

The present invention includes a novel community-driven data acquisition technique for detecting structural impairments in the absence of permanent sensor systems. The method relies on establishing the structural responses of infrastructure systems (e.g., accelerations, displacements, fatigue environment) through collection and filtering of indirect responses of user responses (e.g., a crowd-sourced smart phone acceleration data). The data gathering networks leverage the sensors (e.g., acceleration time histories, GPS data) on smart phones of individuals who have installed a smart phone application and opted-in to provide user anonymous data collection.

The method of the present invention includes one or more of the following novel contributions: (1) collection of spatio-temporal user device responses (i.e. acceleration, GPS data) that contain response information (i.e. frequency, acceleration amplitude) about the individual user vehicle and the infrastructure on which the vehicle is operating (e.g. roadway, bridge); and/or (2) separation and isolation of infrastructure response from individual user responses of the user device/vehicle.

The present invention involves the following major steps:

Obtaining time-varying sensor information on the smartphone including 3D accelerometer, gyroscope and GPS information is collected from smart phone devices and stored for further analysis and also uploaded to our server (without any user specific identification).

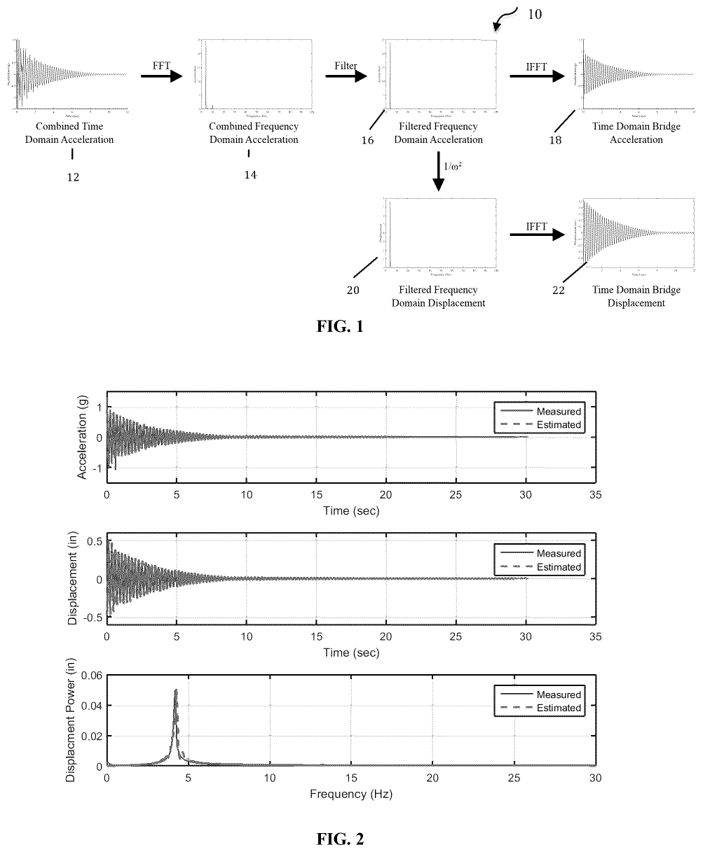

Providing User device responses (e.g. vehicle frequencies) are filtered to distinguish vibration response (e.g. frequencies, acceleration time histories) of supporting structural infrastructure (See FIG. 1).

Estimating structural responses are compared to analytical models and existing data streams for the same structure from different user devices to determine if there has been any significant change with time. Significant changes will trigger additional action to closely inspect the structure for potential impairments.

FIG. 1 is a flow diagram for separating user device and infrastructure responses 10. In step 12, the combined time domain acceleration is obtained. After Fast Fourier Transfer (FFT), the data is displayed in step 14, which includes the combined frequency domain acceleration. Next, in step 16, the data from step 14 is filtered and the filtered frequency domain acceleration is shown. The data from this step is filtered in two ways, as an inverse discrete Fourier transform (IFFT), that yields the results in step 18, which are the time domain bridge acceleration. Alternatively, the data is processed as the 1/ω² and then displayed in step 20 as the filtered frequency domain displacement. This data is then processed via IFFT to, in step 22, provide the final time domain bridge displacement.

The method taught herein allows engineers and stakeholders multiple methods of assessing structural behavior: (1) acceleration data can be used to estimate the stress ranges and stress cycles experienced by the structure (i.e. fatigue assessment, a major concern for structural infrastructure), (2) dynamic response content can be compared to analytical models of specific bridges, and (3) patterns of response of the same structure can be collected and compared against previously collected data.

Modeling, laboratory, and field studies were performed to indirectly assess the behavior of a base structure from a smart phone on a vehicle. The laboratory study comprised a base structure and a secondary structure with separate natural frequencies attached in a static manner. The system was excited, and measurements of acceleration were taken from the smart phone attached to the secondary structure. Additionally, accelerations and strains of the frame were measured to estimate the frame acceleration and displacements. The response of the base structure was estimated from the smart phone on the secondary structure and compared to the known responses. Study results are presented in Table 1. An analytical estimate, using the finite element analysis software OPENSEES, was performed to model the test; the calculated natural frequency was 4.2 Hz. Direct measurements and Structural Response Estimation (SRE) estimates of the test are shown in FIG. 2. All analytical and study results show excellent agreement between SRE indirect measurements and direct measurements.

TABLE 1
Frame SRE Lab Summary

| | Frame | | Estimated | | Percent | |
|---|---|---|---|---|---|---|
| | Frequency | Power | Frequency | Power | Difference (%) | |
| Test | (Hz) | (m) | (Hz) | (m) | Frequency | Power |
| 1 | 4.30 | 0.08 | 4.36 | 0.07 | −1.56 | 17.77 |
| 2 | 4.30 | 0.06 | 4.39 | 0.05 | −2.06 | 11.36 |
| 3 | 4.20 | 0.07 | 4.26 | 0.05 | −1.32 | 16.31 |
| 4 | 4.30 | 0.08 | 4.39 | 0.09 | −2.20 | −15.19 |
| 5 | 4.30 | 0.05 | 4.34 | 0.04 | −1.00 | 9.69 |
| 6 | 4.20 | 0.10 | 4.23 | 0.09 | −0.73 | 8.30 |
| 7 | 4.20 | 0.10 | 4.23 | 0.09 | −0.73 | 11.00 |
| 11 | 4.20 | 0.05 | 4.25 | 0.05 | −1.14 | −2.00 |

TABLE 2
Pedestrian Bridge SRE Summary

| | | | | | Percentage | |
|---|---|---|---|---|---|---|
| | | | | | Difference | |
| | Bridge | Bridge | Monitored | Monitored | Fre- | |
| | Frequency | Power | Frequency | Power | quency | Power |
| Test | (Hz) | (g) | (Hz) | (g) | (%) | (%) |
| Static01 | 3.207 | 0.081 | 3.237 | 0.084 | −0.92 | −3.56 |
| Static02 | 3.197 | 0.070 | 3.226 | 0.072 | −0.91 | −3.63 |
| Walk01 | 3.216 | 0.142 | 3.227 | 0.105 | −0.34 | 26.10 |

FIG. 2 shows three graphs for the Frame SRE Lab Summary. The first graph shows acceleration (g) as a function of time. The second graph shows displacement in inches over time. The third graph shows the displacement power in inches as a function of frequency in hertz (Hz).

A second series of studies were performed on a pedestrian bridge in the field. The smart phone vehicle was a bicycle, which was used as an indirect monitoring vehicle; the acceleration of the bridge and bike were recorded separately. The acceleration from the smart phone on the bicycle was used to estimate the bridge response under two conditions: a stationary bike and a bike being walked across the bridge. Table 2 presents all experimental results and indicates that the SRE estimation of the bridge frequency is within 1% difference of the measured bridge frequency.

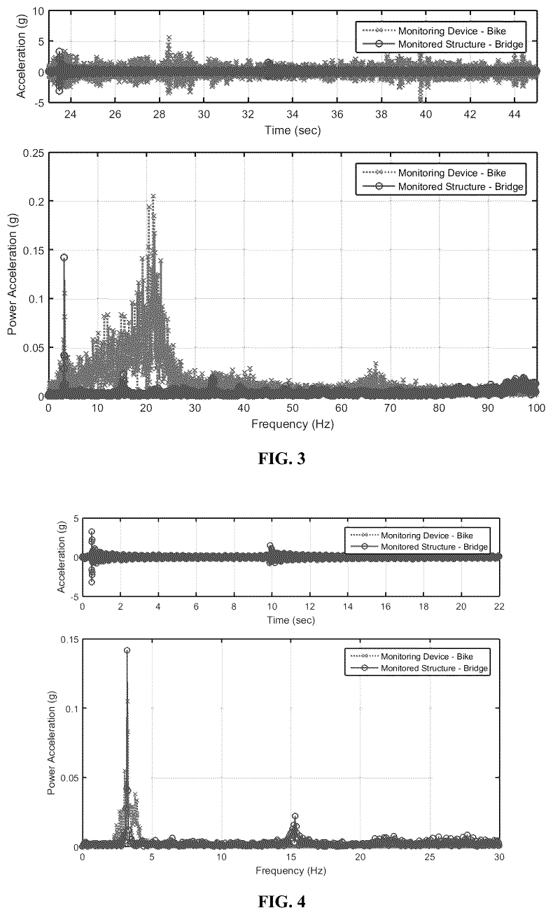

FIG. 3 shows the SRE frequency estimation for the stationary test; this most closely mimics the laboratory setting in which the user device system is stationary. The results are for a Bike Walk Test: Bridge vs. Cell Phone response (raw).

FIG. 4 shows the unfiltered frequency response of the walking test (Bike Walk Test: Bridge vs. Cell Phone response (after SRE)). The bridge frequency (3.2 Hz) can be seen, but there are many additional higher frequencies in the system. After the SRE procedure, these higher frequencies (from the walking bike system) are filtered and FIG. 4 shows the clear presence of the 3.2 Hz bridge frequency.

In one version of the method, infrastructure accelerations established from the proposed method can be converted directly into displacements, strains, and stresses to determine the response of the structure and characterize the fatigue environment. Such an assessment is critical in detecting structures that are experiencing high cycle fatigue at elevated stress ranges. Highway bridges, traffic signal structures, and other infrastructure components are susceptible to this high cycle fatigue.

Other potential applications include the corroboration and monitoring of changes in expected behavior of specific bridge types and even specific bridges. Behavior profiles from analytical models for typical structures are available for comparison to crowd sourced structural behavior profiles. This technique requires a priori knowledge of the nominal structural behavior.

Another extension might be the combination of data streams for individual structures from multiple smart phones and monitor the patterns for any changes. Data streams can be evaluated using any number of Structural Health Monitoring or Structural Impairment Detection algorithms found in the literature (e.g. Story and Fry 2013, Story and Fry 2014). The results of each instance and analysis comprise a health history of the individual structure.

A laboratory test setup was used that consisted of a supported steel plate with separate wooden abutments at either end. The vehicle consists of a two-axle sprung mass instrumented with an iPhone to record the vehicle's acceleration with a sampling frequency of 100 Hz. The vehicle is powered by four individual DC motors controlled by an Arduino UNO and drives across the bridge in a straight line at a constant velocity. An additional accelerometer was mounted directly to the underside of the bridge at midspan; the sampling frequency for this accelerometer was also 100 Hz.

Three rounds of testing were performed, each consisting of 3 vehicle runs over the bridge. Each round considered a different bridge condition. The first round was the baseline round; the data from these runs represent an undamaged bridge. The second round applies simulated damage in the form of lengthening the span between the bridge supports, thus reducing bridge stiffness and lowing the bridge frequency. The third round applies simulated damage by suspending an additional mass from the midspan of the bridge, thus lowering the bridge frequency. Table 3 lists the three bridge scenarios and their approximate expected first mode vibration frequencies.

TABLE 3
Testing round descriptions.

| Test Case | Description | Approx. Frequency (Hz.) |
|---|---|---|
| 1 | Baseline: standard span, | 11.43 |
| | no added mass | |
| 2 | Lengthened span, no | 7.86 |
| | added mass | |
| 3 | Standard span, added | 9.08 |
| | mass | |

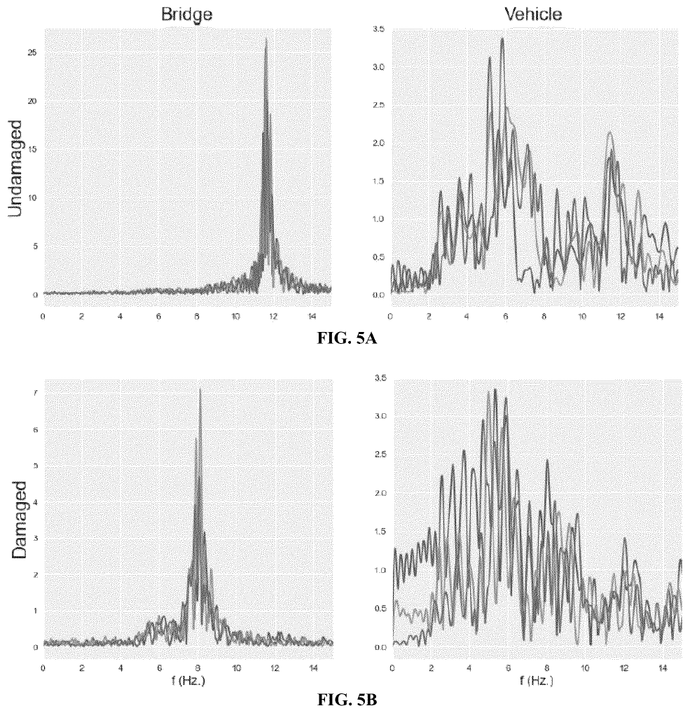

The individual run FFTs for both the bridge and the vehicle for the baseline scenario vs. the lengthened span damage scenario are shown in FIGS. 5A and 5B. The FFTs for the sensor on the bridge all have peak frequencies around 11.50 Hz. and 8.10 Hz. for the undamaged and damaged scenarios, respectively. The FFTs for the vehicle contain high magnitude frequency content between 2.50-7.00 Hz. for both scenarios; this frequency content is due to multiple modes of the vehicle vibrating on its own suspension. The FFTs for the vehicle traversing the baseline bridge contain a second region of high magnitude frequency content from 11.40-11.60 Hz. The FFTs for the vehicle traversing the bridge with the lengthened span contain a second region of high magnitude frequency content from 7.70-8.50 Hz. Despite the presence of high magnitude vehicular frequency content, the bridge peak is identifiable in both the undamaged and damaged scenarios. FIGS. 5A and 5B show individual run FFTs: FIG. 5A baseline (undamaged) vs. FIG. 5B lengthened span (damaged).

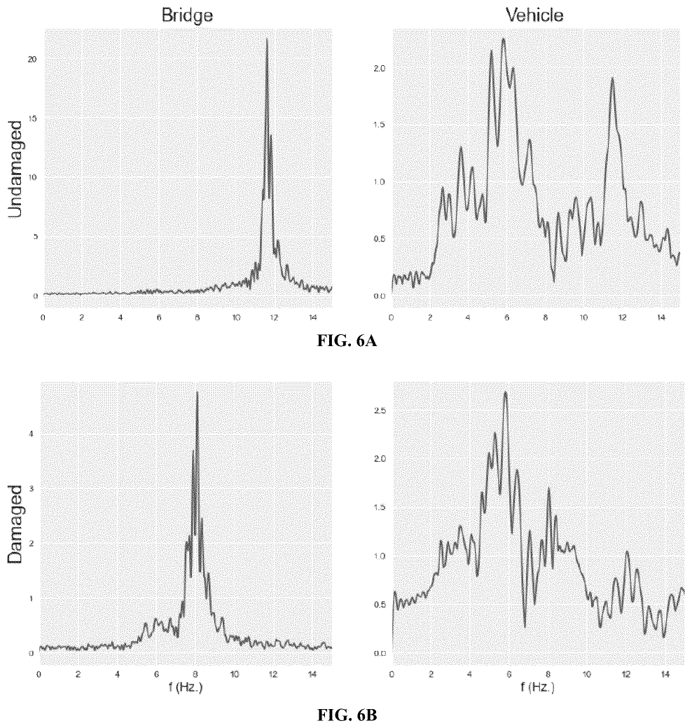

The average FFTs for both the bridge and the vehicle for the baseline scenario vs. the lengthened span damage scenario are shown in FIGS. 6A and 6B. As with the individual run FFTs, the expected bridge frequencies are identifiable in the FFTs for both the undamaged and damaged scenarios. FIGS. 6A and 6B show average FFTs: FIG. 6A baseline (undamaged) vs. FIG. 6B baseline lengthened span (damaged).

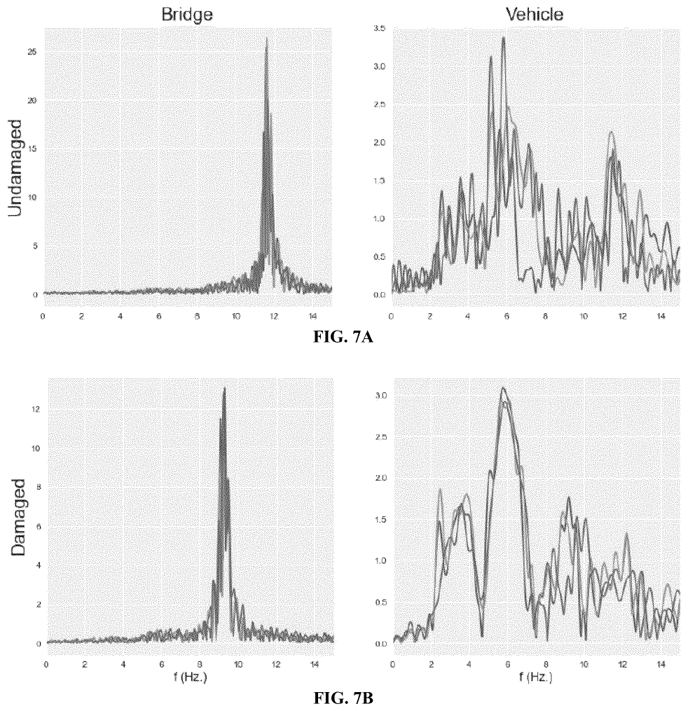

The individual run FFTs for both the bridge and the vehicle for the baseline scenario vs. the added mass damage scenario are shown in FIGS. 7A and 7B. The FFTs for the sensor on the bridge all have peak frequencies around 11.50 Hz. and 9.25 Hz. for the undamaged and damaged scenarios, respectively. As with the previous FFTs shown, the FFTs for the vehicle contain high magnitude frequency content between 2.50-7.00 Hz. for both scenarios due to vehicular vibration. The FFTs for the vehicle traversing the baseline bridge contain a second region of high magnitude frequency content from 11.40-11.60 Hz. The FFTs for the vehicle traversing the bridge with the lengthened span contain a second region of high magnitude frequency content from 8.90-10.00 Hz. Despite the presence of high magnitude vehicular frequency content, the bridge peak is identifiable in both the undamaged and damaged scenarios. FIGS. 7A and 7B show individual run FFTs: FIG. 7A baseline (undamaged) vs. FIG. 7B added mass (damaged).

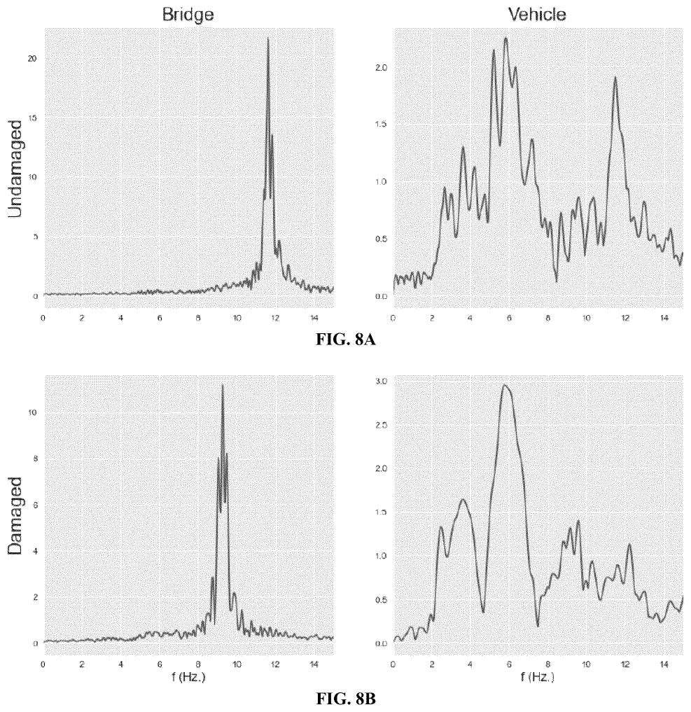

The average FFTs for both the bridge and the vehicle for the baseline scenario vs. the lengthened span damage scenario are shown in FIGS. 8A and 8B. As with the individual run FFTs, the expected bridge frequencies are identifiable in the FFTs for both the undamaged and damaged scenarios. FIGS. 8A and 8B show average FFTs: FIG. 8A baseline (undamaged) vs. FIG. 8B added mass (damaged).

The MUltiple SIgnal Classification (MUSIC) algorithm was also used to calculate vehicle and bridge frequency spectrums. Instead of averaging individual run spectrums together to obtain group frequency spectrums, as was done with the FFTs (see FIGS. 6A and 6B and FIGS. 8A and 8B), group MUSIC spectrums were calculated by providing multiple time histories to the MUSIC algorithm simultaneously, which then outputs a single group frequency spectrum.

Table 4 contains bridge frequency estimation results from all of the runs using spectrums from both the FFT algorithm as well as the MUSIC algorithm. Results include both individual run and group estimations. Since the vehicle used for this experimentation has been independently characterized, it was known that frequency content below 7.50 Hz. corresponded to vehicle frequencies; thus, frequencies below this threshold were manually removed from the frequency spectrums used to estimate bridge frequencies. If prior vehicle characterization is not available, crowdsourcing utilizing a diverse group of vehicles is used to effectively filter out vehicle frequency content from the group frequency spectrums. The bridge frequency estimation procedure used was as follows:
1. Calculate the desired frequency spectrum (individual or group) using either the FFT algorithm or the MUSIC algorithm;
2. Identify the frequency peak with the highest magnitude that is above 7.50 Hz;
3. To account for possible frequency shift, search for additional peaks within 2_βv_of the frequency identified in Step 2 a;
   a. If additional peaks within 2_βv _of the frequency from Step 2 are identified, average all identified peaks together to obtain the bridge frequency estimate; or
   b. If no additional peaks within 2_βv _of the frequency from Step 2 are identified, the frequency from Step 2 is returned as the bridge frequency estimate.

TABLE 4
Bridge frequency extraction results.

| | | Approx. | Extracted Frequencies (Hz.) | | | |
|---|---|---|---|---|---|---|
| Test | | Freq. | Individual | Group | Individual | Group |
| Case | Description | (Hz.) | FFT | FFT | MUSIC | MUSIC |
| 1 | Baseline | 11.43 | 11.43, | 11.50 | 11.72, | 11.81 |
| | | | 11.45, | | 11.68, | |
| | | | 11.52 | | 11.82 | |
| 2 | Lengthened | 7.86 | 8.03, | 8.06 | 9.00, | 8.98 |
| | span | | 8.64, | | 8.95, | |
| | | | 8.45 | | 9.27 | |
| 3 | Added mass | 9.08 | 9.20, | 9.59 | 9.23, | 9.25 |
| | | | 8.89, | | 11.98, | |
| | | | 9.62 | | 9.86 | |

With the data gathered from the time-varying sensor data on a user device, it is possible to correct the structure. Using the data gathered from the user devices it is possible to correct or modify the structure to a frequency similar to that when the building was first installed, or if that data is unavailable, the data is gathered at a first time, and then subsequent measurements are taken to determine changes in the structure, as described herein. Examples of ways in which the bridge can be corrected include adding mass, modifying structural stiffness, repairing damage to the structure, adding supports, or modifying the structure until the frequency of the structure is at or about the frequency measured at the first time.

Thus, the data gathered can be used in a method for detecting impairments of a structure in the absence of permanent sensor systems comprising, consisting essentially of, or consisting of: measuring a frequency of the structure at a first time; obtaining time-varying sensor data on a user device; estimating structural responses of the structure by comparing at least one of: dynamic (short-term) sensor data to an analytical model of the structure; or dynamic sensor data from different user devices at different points in time (long-term), to determine if there has been any significant change in the structure with time; filtering the time-varying sensor data obtained by the multiple user devices or the same device multiple times and to filter a frequency of a user, at least one of: acceleration, GPS data, vehicle frequency, or acceleration amplitude of a vehicle, or both, that cause a vibration of the structure to obtain: a frequency domain acceleration of the structure, and a frequency domain displacement of the structure; performing an inverse discrete Fourier transform (IFFT) on the filtered frequency domain acceleration and the frequency domain displacement; generating a final time domain displacement of the structure to determine impairments of the structure in the absence of permanent sensor systems; inspecting the structure for structural impairments; converting the accelerations into displacements, strains, and stresses of the structure; and correcting the structure by adding mass, modifying structural stiffness, repairing damage to the structure, adding supports, or modifying the structure until the frequency of the structure is at or about the frequency measured at the first time.

In another example, the method for detecting impairments of a structure in the absence of permanent sensor systems comprising, consisting essentially of, or consisting of: measuring or obtaining a frequency of the structure at a first time; obtaining time-varying sensor data on a smartphone with an application that requires user opt-in to gather the time-varying sensor data; estimating structural responses of the structure to an analytical model and an existing data set for the same structure from the time-varying sensor data obtained from different smartphones to determine if there has been any significant change in the structure with time; filtering the time-varying sensor data obtained by the user device to distinguish vibration response of the structure that includes at least one of: 3D accelerometer, gyroscope and GPS information that cause a vibration of the structure to obtain: a frequency domain acceleration of the structure, and a frequency domain displacement of the structure; performing an inverse discrete Fourier transform (IFFT) on the filtered frequency domain acceleration and the frequency domain displacement; generating a final time domain displacement of the structure to determine impairments of the structure in the absence of permanent sensor systems; inspecting the structure for structural impairments; converting the accelerations into displacements, strains, and stresses of the structure; and monitoring, using the time-varying sensor data on the smartphone, the structure until the frequency of the structure by comparing the frequency measured at the first time and a later measured frequency.

Post-frequency detection methods taught in the specification to use ordinary skill to conduct repairs to a structure.

After a bridge frequency, f_{bm}, is determined by the method of the present invention, a

target location for repair is determined using the change from the previously established nominal bridge frequency, f_{bn}, which is calculated as:

$$Δ {f}_{b} = {f}_{b m} - {f}_{b n}$$

Where:
f_{bm} measured bridge frequency determined by the method
f_{bn} nominal operating bridge frequency determined by a previous method (e.g. a previous application of the current method) or estimate from simulations, calculations, etc.
Δf_{b} change in bridge frequency

The sign of Δf_{b} provides a structural engineer skilled in the art the information needed to determine candidate impairment scenarios typically encountered in bridge engineering. Briefly, the bridge frequency, f_{b}, is proportional to the stiffness and mass of a structure:

$${f}_{b} ∼ \frac{k}{m}$$

Where:
k stiffness of the bridge
m mass of the bridge

The stiffness, k, is a function of the bridge support conditions, material properties of the bridge, the cross-sectional properties of the members of the bridge, and the length of the bridge as follows:

$$k ∼ \frac{α EI}{L}$$

Where:
a coefficient representing the contribution to stiffness of boundary supports including, as examples, bearings, pins, integral supports, etc.
E elastic modulus, or Young's modulus, representing the material contribution to stiffness
I Second moment of area representing the cross-sectional contribution to stiffness
L length of the bridge

The target location of repairs and the nature of the repair is therefore determined, using the skill in the art, as follows. Boundary supports can degrade over time and the restraint can increase (e.g., seized bearings) or decrease (e.g., worn bearing pads). Material and cross-sectional properties, collectively known as rigidity, do not typically increase over the life of the structure and typically decrease because of damage, wear, or impairment. Bridge mass and bridge length typically remain nominally constant regardless of bridge condition. Wear and damage leading to impairments affect the stiffness of the bridge and thus the frequency of the bridge in predictable, physics-rooted ways.

TABLE 5
Four (4) bridge example conditions warranting remediation.

| | Deleterious | | Example | |
|---|---|---|---|---|
| Scenario | Condition | Example(s) | Repairs | Citations |
| 1 | Support | Bridge Pier | Jack bridge | Scour Mitigation.” Geostabilization |
| | Settlement | Settlement | pier to | International, 18 Mar. 2024, |
| | | due to | level and | www.geostabilization.com/solutions/ |
| | | scour | reinforce/ | bridges/scour-mitigation/. |
| | | | replace pier | Murtaza, Nadir, et al. “Mitigating |
| | | | foundation | scour at bridge abutments: an |
| | | | | experimental investigation of waste |
| | | | | material as an eco-friendly |
| | | | | solution.” Water 15.21 (2023): |
| | | | | 3798. |
| 2 | Bridge | Fouled | Replace | “VSL Bearing Replacement Unique |
| | bearing | bearing due | bearing | Expertise.” VSL International Ltd. \| |
| | bounding or | to leaking | | Post-Tensioning \| Civil |
| | seizing | or | | Engineering, 2019, |
| | | corrosion | | vsl.com/bearing-replacement-a- |
| | | | | critical-maintenance-operation-that- |
| | | | | requires-specialized-techniques/. |
| | | | | Accessed 8 Oct. 2024. |
| | | | | Noury, Pourya, and Kjell Eriksson. |
| | | | | “Failures of high strength stainless |
| | | | | steel bridge roller bearings: A |
| | | | | review.” Engineering Fracture |
| | | | | Mechanics 180 (2017): 315-329 |
| 3 | Loss of | Debonding | Replace | J. Paul Guyer. An Introduction to |
| | composite | of concrete | shear stud | Steel Bridge Maintenance and |
| | action | bridge deck | connectors, | Repair. Independently Published, |
| | | from steel | replace | 28 Apr. 2018. |
| | | girder | deck | www.cedengineering.com/userfiles/ |
| | | bridge | | An%20Introduction%20to%20Bridge |
| | | | | %20Steel%20Maintenance%20and |
| | | | | %20Repar%20R1.pdf; and |
| | | | | Alsharari, Fahad, et al. “Effect of |
| | | | | the progressive failure of shear |
| | | | | connectors on the behavior of steel- |
| | | | | reinforced concrete composite |
| | | | | girders.” Buildings 12.5 (2022): |
| | | | | 596. |
| 4 | Bridge Span | Loss of | Add steel | J. Paul Guyer. An Introduction to |
| | Damage | section due | cover | Steel Bridge Maintenance and |
| | | to | plates or | Repair. Independently Published, |
| | | corrosion | angles, | 28 Apr. 2018; and |
| | | or fatigue | tensioned | Zhang, Chaobo, Chih-chen Chang, |
| | | | cables, | and Maziar Jamshidi. “Concrete |
| | | | FRP wraps | bridge surface damage detection |
| | | | etc. | using a single-stage detector.” |
| | | | | Computer-Aided Civil and |
| | | | | Infrastructure Engineering 35.4 |
| | | | | (2020): 389-409. |

If Δf_{b}=0, no frequency change has occurred and no detectable impairments exist. If Δf_{b}>0, the structural response has stiffened indicating, almost certainly, an unintended and unwanted added restraint from the supporting boundary conditions. Examples of such conditions include seized bearings, excessive thermal expansions, and support settlements. In such cases, a positive Δf_{b} would likely indicate a support-related issue and the appropriate and well-known structural remedies would be employed as indicated in Table 5, Examples 1 and 2. Example 1 illustrates a scenario within the method.

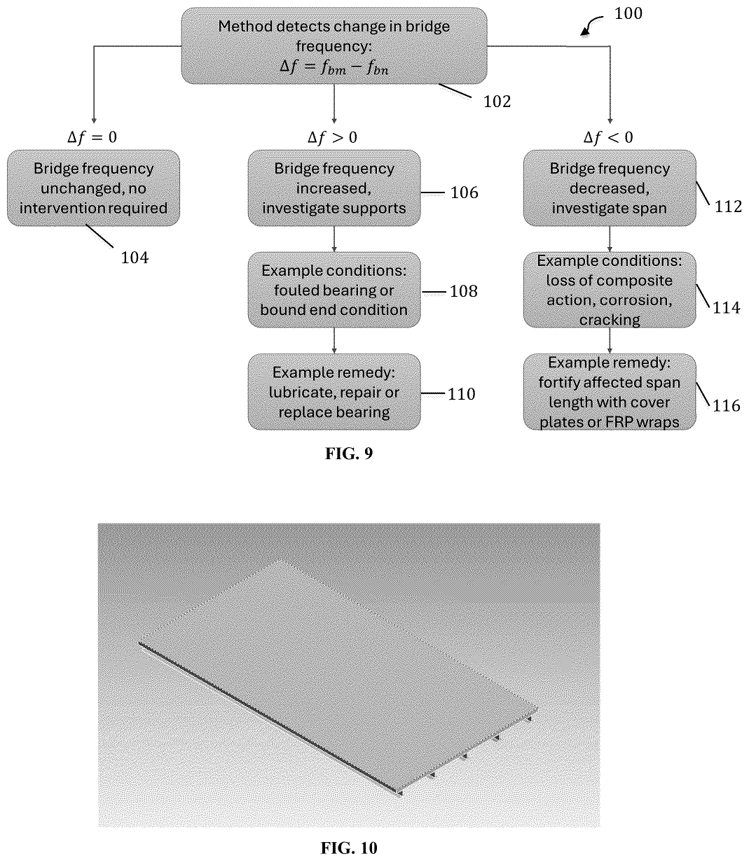

If Δf_{b}<0, the structural response has become more flexible indicating a few candidate impairment scenarios typically affecting the superstructure of the bridge. These impairments include loss of composite action between the deck and superstructure and span damage including corrosion and fatigue cracks. In such cases, a negative Δf_{b} would indicate a span-related issue and the appropriate and well-known structural remedies would be employed as indicated in Table 4, Scenarios 3 and 4. Example 2 illustrates this scenario within the method. FIG. 9 shows a flowchart 100 of the method of detecting the anomaly and identifying the repair needed using the detailed results from bridge simulations. In step 102, the process begins with a method of detecting a change in a bridge frequency. In step 104, it is determined that if Δf_{b}=0, no frequency change has occurred and no detectable impairments exist, and therefore there is no current need to repair. In step 106, it is determined that Δf_{b}>0, then in step 106 the structural response has stiffened indicating, almost certainly, an unintended and unwanted added restraint from the supporting boundary conditions. In step 108 it is determined whether the bridge conditions are that a bearing is fouled or a bound end condition exists. Finally, in step 110, it is determined that the bearing needs adjustment or repair, which repair can be to lubricate the bearing, repair, or replace the bearing. Finally, in step 112, if Δf_{b}<0, then the structural response has become more flexible indicating a few candidate impairment scenarios typically affecting the superstructure of the bridge. In step 114, the bridge impairments include loss of composite action between the deck and superstructure and span damage including corrosion and fatigue cracks. In such cases, a negative Δf_{b} would indicate a span-related issue and the appropriate and well-known structural remedies would be employed as indicated in Table 4, Scenarios 3 and 4. In step 116, the bridge is repaired by fortifying the affected span length is cover plates or fiber-reinforced polymer (FRP) wraps.

Example Baseline. These examples establish nominal behavior, behavior resulting from bearing failure, and behavior resulting from loss of concrete section on a simply supported composite bridge with steel girders supporting a reinforced concrete deck.

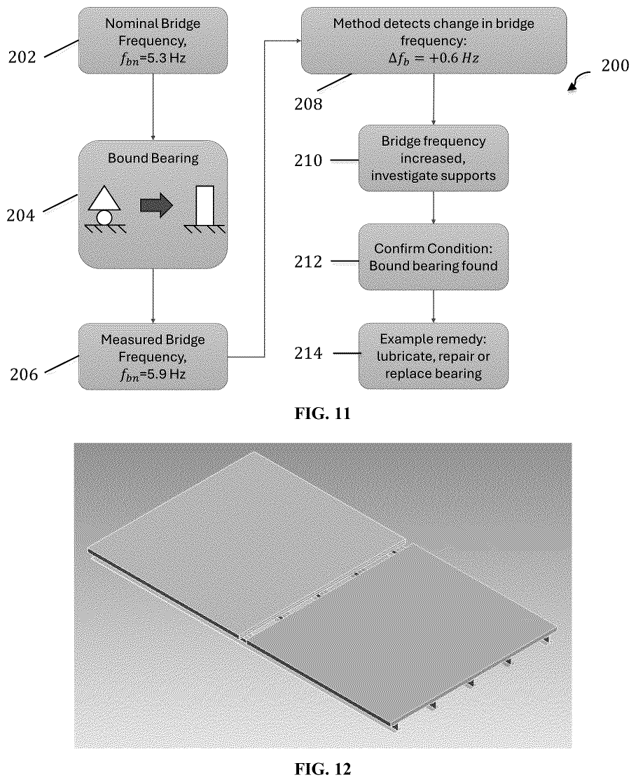

FIG. 10 illustrates the 3D ANSYS model used to simulate baseline and damaged cases. In both examples, the nominal, undamaged bridge has the following characteristics:
40′ span length and simply supported boundary conditions (i.e., pinned-roller supports).
5, W12×65 steel girders supported at the ends with pins and rollers (simply supported).
Girder material is structural steel with E=29,000 ksi, A=19.1 in², I=533 in⁴
Girders support a 6″ thick reinforced concrete deck and fully composite connection between the girders and deck continuously along the length.
Slab material is 5.8 ksi reinforced concrete that is 22′ wide and 6″ thick.
The undamaged, nominal bridge frequency, f_{bn}, is 5.3 Hz.

### Example 1: Bearing Failure

This example simulates a bearing failure in which a single bearing binds and no longer permits rotation of the support; the roller support becomes a fixed support. In ANSYS, the simulation included fixing a single roller support (5 pin supports and 4 roller supports untouched) to a fixed support. This resulted in a stiffening of the structure and a f_{bm} of 5.9 Hz and a Δf_{b}=+0.6 Hz.

FIG. 11 illustrates the analytical flowchart 200 based on this new frequency in the method for the identification and repair of a bridge bearing. In step 202, the nominal bridge frequency is measured. At the frequency detected, in step 204 the type of bearing in input.

Next, in step 206 a new frequency is detected. In step 208, the method detected a change in frequency that is indicative of an anomaly in the bearing(s). In step 210, it is determined that the bridge frequency has increased, which is confirmed in step 212. Finally, in step 214 the bearing anomaly is remedied by lubricating, repairing, or replacing the bearing.

### Example 2: Concrete Section Loss

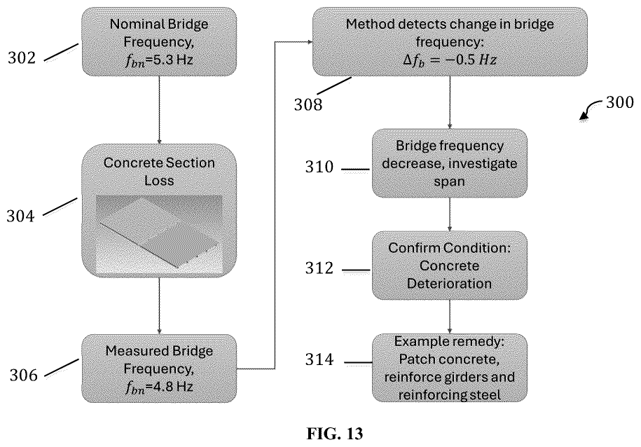

This example simulates a span stiffness reduction caused by loss of concrete section at the midspan. Specifically, a 1 foot wide, 6″ concrete degradation is modelled as shown in FIG. 12. The loss of concrete impairment reduces the measured frequency from 5.3 Hz to f_{bm}=4.8 Hz. The Δf_{b}=−0.5 Hz indicates a decrease in stiffness and a likely span defect; following the procedure in the method. FIG. 13 is a flowchart 300 of the identification and repair of a bridge section having a loss of concrete impairment. In step 302, the nominal bridge frequency is measured. At the frequency detected, in step 304 it is determined that there has been a loss in a section of concrete. Next, in step 306 a new frequency is detected. In step 308, the method detected a change in frequency that is indicative of concrete loss anomaly. In step 310, it is determined that the bridge frequency has decreased from a loss of concrete, which loss of concrete or deterioration of the concrete is confirmed in step 312. Finally, in step 314, the loss of concrete or concrete deterioration is remedied by patching the concrete, adding reinforcing girders, or reinforcing steel.

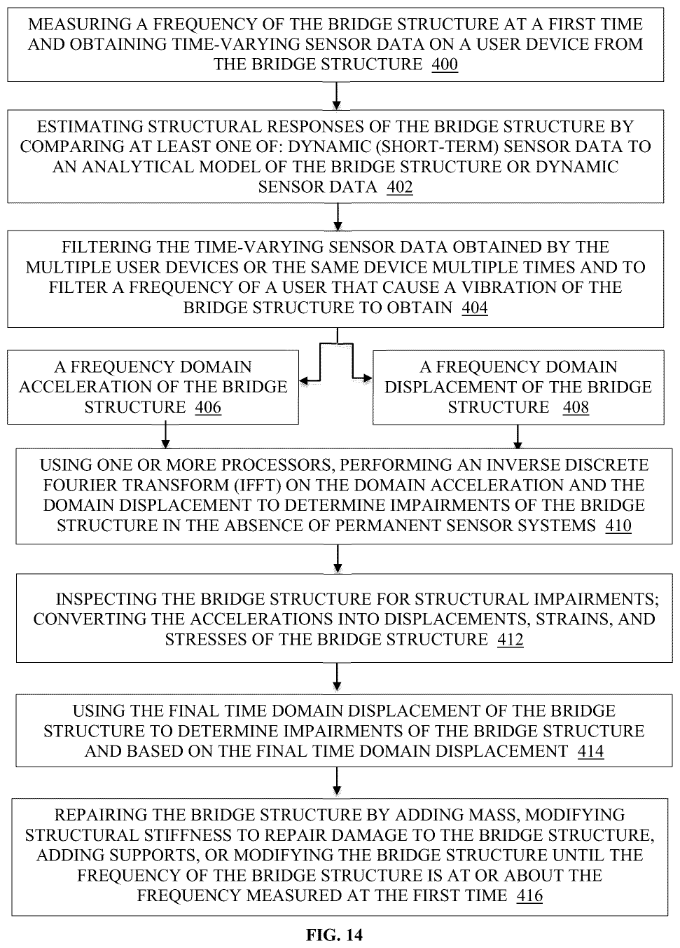

FIG. 14 shows a flowchart of a method of the present disclosure for detecting and correcting impairments of a bridge structure in the absence of permanent sensor systems. In step 400, the method begins by measuring a frequency of the bridge structure at a first time and obtaining time-varying sensor data on a user device from the bridge structure. In step 402, estimating structural responses of the bridge structure is accomplished by comparing at least one of: dynamic (short-term) sensor data to an analytical model of the bridge structure or dynamic sensor data from different user devices at different points in time (long-term), to determine if there has been any significant change in the bridge structure with time. Next, in step 404, the method continues by filtering the time-varying sensor data obtained by the multiple user devices or the same device multiple times and to filter a frequency of a user, at least one of: acceleration, GPS data, vehicle frequency, or acceleration amplitude of a vehicle, or both, that cause a vibration of the bridge structure to obtain: a frequency domain acceleration of the bridge structure (step 406), and a frequency domain displacement of the bridge structure (Step 408). These frequency domain acceleration and frequency domain displacement are obtained, and in step 410, using one or more processors, performing an inverse discrete Fourier transform (IFFT) on the filtered frequency domain acceleration and the frequency domain displacement to calculate a final time domain displacement of the bridge structure to determine impairments of the bridge structure in the absence of permanent sensor systems. In step 412, the method continues by inspecting the bridge structure for structural impairments, and converting the accelerations into displacements, strains, and stresses of the bridge structure. In step, 414, using the final time domain displacement of the bridge structure impairments of the bridge structure are determined and based on the final time domain displacement. Finally, in step 416, the method concludes by repairing the bridge structure by adding mass, modifying structural stiffness to repair damage to the bridge structure, adding supports, or modifying the bridge structure until the frequency of the bridge structure is at or about the frequency measured at the first time.

The above examples provide several example impairments identified by the method including loss of composite action in a composite girder bridge, horizontal shear cracks in a timber structure, and localized section loss in girder bridge. [See inventor's publication, Sitton, Jase D., Dinesh Rajan, and Brett A. Story. “Damage scenario analysis of bridges using crowdsourced smartphone data from passing vehicles.” Computer-Aided Civil and Infrastructure Engineering 39.9 (2024): 1257-1274], relevant portions incorporated herein by reference. The impairments were detected as described hereinabove.

A person of skill in the art would readily recognize that steps of various above-described methods can be performed by one or more programmed computers, each having one or more computer processors. Herein, some embodiments are also intended to cover program storage devices, e.g., digital data storage media, which are machine or computer-readable and encode machine-executable or computer-executable programs of instructions, wherein the instructions perform some or all of the steps of said above-described methods. The program storage devices may be, e.g., digital memories, magnetic storage media such as magnetic disks and magnetic tapes, hard drives, or optically readable digital data storage media. The embodiments are also intended to cover computers programmed to perform said steps of the above-described methods.

A risk score of the present invention may be calculated with an algorithm using well-known statistical analysis techniques. Non-limiting examples of statistical analysis techniques that may be used to calculate the risk score include cross-correlation, Principal Components Analysis (PCA), factor rotation, Logistic Regression (LogReg), Linear Discriminant Analysis (LDA), Eigengene Linear Discriminant Analysis (ELDA), Support Vector Machines (SVM), Random Forest (RF), Recursive Partitioning Tree (RPART), related decision tree classification techniques, Shrunken Centroids (SC), StepAIC, Kth-Nearest Neighbor, Boosting, Decision Trees, Neural Networks, Bayesian Networks, Support Vector Machines, and Hidden Markov Models, Linear Regression or classification algorithms, Nonlinear Regression or classification algorithms, analysis of variants (ANOVA), hierarchical analysis or clustering algorithms; hierarchical algorithms using decision trees; kernel based machine algorithms such as kernel partial least squares algorithms, kernel matching pursuit algorithms, kernel Fisher's discriminate analysis algorithms, or kernel principal components analysis algorithms. In preferred embodiments, the risk score may be calculated using a random forest algorithm using the concentrations of three or more sample analytes in the panel of biomarkers. In an exemplary embodiment, the risk score is calculated as described in the examples.

The functions of the various elements shown in the figures, including any functional blocks labeled as “modules”, may be provided through the use of dedicated hardware as well as hardware capable of executing software in association with the appropriate software. When provided by a processor, the functions may be provided by a single dedicated processor, by a single shared processor, or by a plurality of individual processors, some of which may be shared. Moreover, explicit use of the term “module” should not be construed to refer exclusively to hardware capable of executing software, and may implicitly include, without limitation, digital signal processor (DSP) hardware, network processor, application-specific integrated circuit (ASIC), field-programmable gate array (FPGA), read-only memory (ROM) for storing software, random access memory (RAM), and nonvolatile storage. Other hardware, conventional and/or custom, may also be included.

It is contemplated that any embodiment discussed in this specification can be implemented with respect to any method, kit, reagent, or composition of the invention, and vice versa. Furthermore, compositions of the invention can be used to achieve methods of the invention.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

All publications and patent applications mentioned in the specification are indicative of the level of skill of those skilled in the art to which this invention pertains. All publications and patent applications are herein incorporated by reference to the same extent as if each individual publication or patent application was specifically and individually indicated to be incorporated by reference.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps. In embodiments of any of the compositions and methods provided herein, “comprising” may be replaced with “consisting essentially of” or “consisting of”. As used herein, the phrase “consisting essentially of” requires the specified integer(s) or steps as well as those that do not materially affect the character or function of the claimed invention. As used herein, the term “consisting” is used to indicate the presence of the recited integer (e.g., a feature, an element, a characteristic, a property, a method/process step or a limitation) or group of integers (e.g., feature(s), element(s), characteristic(s), propertie(s), method/process steps or limitation(s)) only.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

As used herein, words of approximation such as, without limitation, “about”, “substantial” or “substantially” refers to a condition that when so modified is understood to not necessarily be absolute or perfect but would be considered close enough to those of ordinary skill in the art to warrant designating the condition as being present. The extent to which the description may vary will depend on how great a change can be instituted and still have one of ordinary skilled in the art recognize the modified feature as still having the required characteristics and capabilities of the unmodified feature. In general, but subject to the preceding discussion, a numerical value herein that is modified by a word of approximation such as “about” may vary from the stated value by at least ±1, 2, 3, 4, 5, 6, 7, 10, 12 or 15%.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

### REFERENCES

Costa Antunes, P., Miguel Dias, J., Varum, H., and Andre, P. (2014). “Dynamic structural health monitoring of a civil engineering structure with a POF accelerometer”. Sensor Review, 34(1), 36-41.
Brownjohn, J. (2007). “Structural health monitoring of civil infrastructure”. Philosophical Transactions of the Royal Society A: Mathematical, Physical and Engineering Sciences, 365(1851), 589-622.
Farrar, C., Doebling, S., and Nix, D. (2001). “Vibration-based structural damage identification”. Philosophical Transactions of the Royal Society A: Mathematical, Physical and Engineering Sciences, 359(1778), 131-149.
Feng, M., Fukuda, Y., Mizuta, M., and Ozer, E. (2015). “Citizen Sensors for SHM: Use of Accelerometer Data from Smartphones”. Sensors, 15(2), 2980-2998.
Ha, D., Park, H., Choi, S., and Kim, Y. (2013). “A Wireless MEMS-Based Inclinometer Sensor Node for Structural Health Monitoring”. Sensors, 13(12), 16090-16104.
Ozer, E., Feng, M., and Feng, D. (2015). “Citizen Sensors for SHM: Towards a Crowdsourcing Platform”. Sensors, 15(6), 14591-14614.
Park, K., Kim, S., Park, H., and Lee, K. (2005). “The determination of bridge displacement using measured acceleration”. Engineering Structures, 27(3), 371-378.
Story, B.A., and Fry, G.T. (2013). Methodology for Designing Diagnostic Data Streams for Use in a Structural Impairment Detection System,” Journal of Bridge Engineering, 10.1061/(ASCE)BE.1943-5592.0000556, 04013020.
Story, B.A., and Fry, G.T. (2014). “A Structural Impairment Detection System Using Competitive Arrays of Artificial Neural Networks,” Computer-Aided Civil and Infrastructure Engineering, 29: 180-190.

What is claimed is:

1. A method for detecting and correcting impairments of a bridge structure in the absence of permanent sensor systems comprising:
measuring a frequency of the bridge structure at a first time;
obtaining time-varying sensor data on a user device from the bridge structure;
estimating structural responses of the bridge structure by comparing at least one of: dynamic (short-term) sensor data to an analytical model of the bridge structure or dynamic sensor data from different user devices at different points in time (long-term), to determine if there has been any significant change in the bridge structure with time;
filtering the time-varying sensor data obtained by the multiple user devices or the same device multiple times and to filter a frequency of a user, at least one of: acceleration, GPS data, vehicle frequency, or acceleration amplitude of a vehicle, or both, that cause a vibration of the bridge structure to obtain:
a frequency domain acceleration of the bridge structure, and
a frequency domain displacement of the bridge structure; and
using one or more processors, performing an inverse discrete Fourier transform (IFFT) on the filtered frequency domain acceleration and the frequency domain displacement to calculate a final time domain displacement of the bridge structure to determine impairments of the bridge structure in the absence of permanent sensor systems;
inspecting the bridge structure for structural impairments;
converting the accelerations into displacements, strains, and stresses of the bridge structure;
using the final time domain displacement of the bridge structure to determine impairments of the bridge structure and based on the final time domain displacement;
repairing the bridge structure by adding mass, modifying structural stiffness to repair damage to the bridge structure, adding supports, or modifying the bridge structure until the frequency of the bridge structure is at or about the frequency measured at the first time.

2. The method of claim 1, wherein the repairs are selected from lubricating, repairing or replacing a bearing, patching deteriorated or missing concrete, adding reinforcing girders, or reinforcing steel.

3. The method of claim 1, wherein the time-varying sensor information is captured by a smartphone and the time-varying sensor information is selected from 3D accelerometer, gyroscope and GPS information.

4. The method of claim 1, wherein the time-varying sensor information is obtained without user-specific identification.

5. The method of claim 1, wherein the time-varying sensor information is uploaded to a server and stored for subsequent analysis.

6. The method of claim 1, wherein the time-varying sensor data is filtered by vehicle frequencies.

7. The method of claim 1, wherein to distinguish vibration response of supporting structural infrastructure is selected from frequencies and/or acceleration time histories.

8. The method of claim 1, wherein the user device comprises an application that requires user opt-in to gather the time-varying sensor data.

9. The method of claim 1, further comprising the step of calculating a structural behavior profile from analytical models for a typical structure and comparing the structural behavior profile to the time-varying sensor data obtained from the user devices to the calculated structural behavior profile.

10. The method of claim 1, wherein the steps of obtaining time-varying sensor data; filtering the time-varying sensor data; and estimating structural responses is conducted via a code segment in non-transitory memory.

11. A method for detecting impairments of a bridge structure in the absence of permanent sensor systems comprising:
measuring or obtaining a frequency of the bridge structure at a first time;
obtaining time-varying sensor data on a smartphone with an application that requires user opt-in to gather the time-varying sensor data;
estimating structural responses of the bridge structure to an analytical model and an existing data set for the same structure from the time-varying sensor data obtained from different smartphones to determine if there has been any significant change in the bridge structure with time;
filtering the time-varying sensor data obtained by the user device to distinguish vibration response of the bridge structure that includes at least one of: 3D accelerometer, gyroscope and GPS information that cause a vibration of the bridge structure to obtain:
a frequency domain acceleration of the bridge structure, and
a frequency domain displacement of the bridge structure;
using one or more processors, performing an inverse discrete Fourier transform (IFFT) on the filtered frequency domain acceleration and the frequency domain displacement;
generating a final time domain displacement of the bridge structure to determine impairments of the bridge structure in the absence of permanent sensor systems;
inspecting the bridge structure for structural impairments;
converting the accelerations into displacements, strains, and stresses of the bridge structure;
monitoring, using the time-varying sensor data on the smartphone, the bridge structure, until the frequency of the bridge structure is obtained by comparing the frequency measured at the first time and a later measured frequency, and based on the final time domain displacement;
repairing the bridge structure to a frequency similar to that when the bridge structure was first installed.

12. The method of claim Error! Reference source not found., wherein the repairs are selected from lubricating, repairing or replacing a bearing, patching deteriorated or missing concrete, adding reinforcing girders, or reinforcing steel.

13. The method of claim Error! Reference source not found., wherein the time-varying sensor information is obtained without user-specific identification.

14. The method of claim Error! Reference source not found., wherein the time-varying sensor information is uploaded to a server and stored for subsequent analysis.

15. The method of claim Error! Reference source not found., wherein the time-varying sensor data is filtered by vehicle frequencies.

16. The method of claim Error! Reference source not found., wherein to distinguish vibration response of supporting structural infrastructure is selected from frequencies and/or acceleration time histories.

17. The method of claim Error! Reference source not found., wherein the smartphones comprises an application that requires user opt-in to gather the time-varying sensor data.

18. The method of claim Error! Reference source not found., further comprising the step of calculating a structural behavior profile from analytical models for a typical structure and comparing the structural behavior profile to the time-varying sensor data obtained from the smartphone to the calculated structural behavior profile.

19. A non-transitory computer readable medium for detecting impairments of a bridge structure in the absence of permanent sensor systems via crowdsourcing, comprising instructions stored thereon, that when executed by a computer having a communications interface, one or more databases and one or more processors communicably coupled to the interface and one or more databases, perform the steps comprising:
measuring or obtaining a frequency of the bridge structure at a first time;
obtaining time-varying sensor data on a user device from the bridge structure;
using the one or more processors, estimating structural responses of the bridge structure by comparing at least one of: dynamic (short-term) sensor data to an analytical model of the bridge structure; or dynamic sensor data from different user devices at different points in time (long-term), to determine if there has been any significant change in the bridge structure with time;
filtering the time-varying sensor data obtained by the multiple user devices or the same device multiple times and to filter a frequency of a user, at least one of: acceleration, GPS data, vehicle frequency, or acceleration amplitude of a vehicle, or both, that cause a vibration of the bridge structure to obtain:
a frequency domain acceleration of the bridge structure, and
a frequency domain displacement of the bridge structure;
using the one or more processors, performing an inverse discrete Fourier transform (IFFT) on the filtered frequency domain acceleration and the frequency domain displacement;
generating a final time domain displacement of the bridge structure to determine impairments of the bridge structure in the absence of permanent sensor systems;
outputting a list of structural impairments;
converting the accelerations into displacements, strains, and stresses of the bridge structure; and
using the displacements, strains, and stresses of the bridge structure to provide instructions with repairs to the bridge structure by adding mass, modifying structural stiffness, repairing damage to the bridge structure, adding supports, or modifying the bridge structure until the frequency of the bridge structure is at or about the frequency measured at the first time;
at least one of storing or displaying the results obtained thereby; and
repairing the bridge structure to a frequency similar to that when the bridge structure was first installed using the instructions with repairs for the bridge structure based on the final time domain displacement.

20. A computerized method for detecting and correcting impairments of a bridge structure in the absence of permanent sensor systems via crowdsourcing, comprising:
measuring or obtaining a frequency of the bridge structure at a first time;
obtaining time-varying sensor data on a user device from the bridge structure;
using one or more processors, estimating structural responses of the bridge structure by comparing at least one of: dynamic (short-term) sensor data to an analytical model of the bridge structure; or dynamic sensor data from different user devices at different points in time (long-term), to determine if there has been any significant change in the bridge structure with time;
filtering the time-varying sensor data obtained by the multiple user devices or the same device multiple times and to filter a frequency of a user, at least one of: acceleration, GPS data, vehicle frequency, or acceleration amplitude of a vehicle, or both, that cause a vibration of the bridge structure to obtain:
a frequency domain acceleration of the bridge structure, and
a frequency domain displacement of the bridge structure;
using the one or more processors, performing an inverse discrete Fourier transform (IFFT) on the filtered frequency domain acceleration and the frequency domain displacement;
generating a final time domain displacement of the bridge structure to determine impairments of the bridge structure in the absence of permanent sensor systems;
outputting a list of structural impairments;
converting the accelerations into displacements, strains, and stresses of the bridge structure;
using the displacements, strains, and stresses of the bridge structure to generate instructions to repair the bridge structure by adding mass, modifying structural stiffness, repairing damage to the bridge structure, adding supports, or modifying the bridge structure until the frequency of the bridge structure is at or about the frequency measured at the first time; and
repairing the bridge structure to a frequency similar to that when the bridge structure was first installed using the instructions with repairs for the bridge structure based on the final time domain displacement.
